(19) United States
(12) Patent Application Publication
(10) Pub. No.: US 2025/0012369 A1
(43) Pub. Date: Jan. 9, 2025

(54) NOVEL VALVE AND INFLATABLE BRA

(71) Applicant: ZIGAN LIN, Shenzhen (CN)

(72) Inventor: ZIGAN LIN, Shenzhen (CN)

(21) Appl. No.: 18/894,303

(22) Filed: Sep. 24, 2024

(51) Int. Cl. F16K 15/20; A41C 3/10

(52) U.S. Cl. CPC F16K 15/205; A41C 3/10

(57) ABSTRACT

The utility model relates to a novel valve and an inflatable bra. The novel valve comprises a bracket, a sealing plug, a supporting block and an air valve. One end of the bracket is provided with an air inlet, and one side of the bracket is provided with an air outlet communicating with the air inlet. The sealing plug is used for closing or opening the air inlet. The supporting block is arranged at an end, near the air inlet, of the bracket, and the supporting block is provided with a through hole. One end of the through hole communicates with the air inlet, and the other end communicates with the air outlet. The air valve is movably connected in the bracket, and the air valve is used for closing or opening the through hole.

### BACKGROUND OF THE INVENTION

### Technical Field

The utility model relates to the technical field of inflatable accessories, in particular to a novel valve and an inflatable bra.

### Description of Related Art

Inflatable bras can somewhat enhance women's bust size, reducing the self-consciousness of some women. As a result, inflatable bras are gaining popularity among more and more women. The inflatable bras commonly available in the market have two airbags that are interconnected and share a single inflation valve. However, the poor sealing of the inflation valve can lead to air leakage, compromising the desired effect during prolonged wear.

### BRIEF SUMMARY OF THE INVENTION

In view of this, it is necessary to provide a novel valve and an inflatable bra with good air tightness to solve the above problems.

A novel valve comprises a bracket, a sealing plug, a supporting block and an air valve, wherein one end of the bracket is provided with an air inlet, and one side of the bracket is provided with an air outlet communicating with the air inlet; the sealing plug is used for closing or opening the air inlet, the supporting block is arranged at an end, near the air inlet, of the bracket, and the supporting block is provided with a through hole; one end of the through hole communicates with the air inlet, and the other end communicates with the air outlet; and the air valve is movably connected in the bracket, and the air valve is used for closing or opening the through hole.

In one embodiment, the bracket comprises an air inlet pipe, an air outlet pipe and a bottom cover, with the air inlet at one end of the air inlet pipe and the air outlet at one end of the air outlet pipe; and the air outlet pipe communicates with one side of the air inlet pipe, and the bottom cover covers an end, away from the air inlet, of the air inlet pipe.

In one embodiment, the novel valve further comprises a sealing member and a housing, wherein the sealing member is sleeved at one end of the sealing plug and used for sealing the air inlet pipe, and the housing covers the bracket.

In one embodiment, the novel valve further comprises an elastic member, wherein one end of the elastic member abuts against the bottom cover, and the other end abuts against the air valve.

In one embodiment, the novel valve further comprises a gasket, wherein the gasket is installed at an end, away from the through hole, of the supporting block, the gasket is provided with a via hole, one end of the via hole communicates with the through hole and the other end communicates with the air outlet pipe, and the gasket is used for supporting the air valve.

In one embodiment, one end of the elastic member abuts against the gasket, and the other end abuts against the air valve.

In one embodiment, the air valve comprises a bottom plate and a protrusion connected to the bottom plate, the bottom plate is used for being connected to one side of the supporting block, and the protrusion penetrates through the supporting block.

In one embodiment, the novel valve further comprises a jacket, wherein the jacket is sleeved on the protrusion, one side of the jacket abuts against the bottom plate, and the other side is used for abutting against one side of the supporting block.

In one embodiment, the novel valve further comprises a valve sleeve, wherein the valve sleeve comprises a shell and a conduit communicating with the shell, the shell is used for abutting against one end of the bracket, an end, away from the shell, of the conduit is used for abutting against the protrusion, and the end, away from the shell, of the conduit is provided with an air slot.

An inflatable bra comprises the novel valve as described above.

Compared with the prior art, the utility model has the following beneficial effects.

The novel valve is arranged at the end, near the air inlet, of the bracket through the supporting block, and the air valve opens or closes the through hole, thereby realizing inflation or deflation. The air inlet can be sealed by the sealing plug, and the through hole can be closed by the air valve, thus improving the air tightness. The novel valve is convenient to use and has a good air leakage prevention effect.

### BRIEF DESCRIPTION OF THE SEVERAL VIEWS OF THE DRAWINGS

FIG. 1 is a schematic diagram of the assembly structure of a novel valve according to a first embodiment of the utility model;

FIG. 2 is a perspective view taken along line A-A of the novel valve shown in FIG. 1, where the housing is not shown;

FIG. 3 is an exploded view of the novel valve shown in FIG. 2, where the valve sleeve is not shown;

FIG. 4 is a structural diagram of a novel valve according to a second embodiment of the utility model;

FIG. 5 is an exploded view of the novel valve shown in FIG. 4;

FIG. 6 is a structural diagram of a novel valve according to a third embodiment of the utility model;

FIG. 7 is an exploded view of the novel valve shown in FIG. 6;

FIG. 8 is a structural diagram of a novel valve according to a fourth embodiment of the utility model;

FIG. 9 is an exploded view of the novel valve shown in FIG. 8;

FIG. 10 is a structural diagram of a novel valve according to a fifth embodiment of the utility model; and

FIG. 11 is a structural diagram of a novel valve according to a sixth embodiment of the utility model

### DESCRIPTION OF REFERENCE NUMERALS

100. novel valve;
10. bracket; 101. air inlet; 102. air outlet; 11. air inlet pipe; 12. air outlet pipe; 13. bottom cover; 20. sealing plug; 30. supporting block; 301. through hole; 40. air valve; 41. bottom plate; 410. receiving cavity; 42. protrusion; 50. elastic member; 60. jacket; 70. sealing member; 80. housing; 90. valve sleeve; 91. shell; 92. conduit; 920. air slot;
100a. novel valve;
13a. bottom cover; 40a. air valve; 41a. bottom plate; 42a. protrusion; 50a. elastic member; 51a. first elastic part; 52a. second elastic part;
100b. novel valve;
13b. bottom cover; 40b. air valve; 41b. bottom plate; 42b. protrusion; 43b. boss; 50b. elastic member;
100c. novel valve;
10c. bracket; 11c. air inlet pipe; 111c. base part; 1110c. air hole; 112c. pipe part; 12c. air outlet pipe; 20c. sealing plug; 30c. supporting block; 301c. through hole; 40c. air valve; 50c. elastic member; 90c. gasket; 91c. via hole;
100d. novel valve;
30d. supporting block; 301d. through hole; 40d. air valve; 90d. gasket; 91d. via hole; 100e. novel valve;
11e. air inlet pipe; 111e. base part; 40e. air valve; 50e. elastic member.

### DETAILED DESCRIPTION OF THE INVENTION

In order to make the above objects, features and advantages of the utility model more obvious and understandable, the following detailed description of the utility model will be made with reference to the accompanying drawings. In the following description, numerous specific details are set forth in order to provide a thorough understanding of the utility model. However, the utility model can be implemented in many other ways different from those described here, and those skilled in the art can make similar improvements without violating the connotation of the utility model. Therefore, the utility model is not limited by the specific embodiments disclosed below.

In the description of the utility model, it should be understood that directional or positional relationships indicated by the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial” and “circumferential” are based on the directional or positional relationships shown in the drawings, which are only for the convenience of describing the utility model and simplifying the description, but do not indicate or imply that the referred devices or elements must have a specific orientation or be constructed and operated in a specific orientation, so they cannot be understood as limiting the utility model.

In addition, the terms “first” and “second” are only used for descriptive purposes, and cannot be understood as indicating or implying relative importance or implicitly indicating the number of indicated technical features. Therefore, the features defined with “first” and “second” may include one or more of the features explicitly or implicitly. In the description of the utility model, “multiple” means at least two, such as two, three, etc., unless otherwise specifically defined.

In the utility model, unless otherwise specified and limited, the terms “install”, “connect” and “fix” should be understood in a broad sense, for example, they may be fixed connection, detachable connection, integrated connection, mechanical connection, electrical connection, direct connection, indirect connection through an intermediate medium, internal communication between two elements or interaction between two elements, unless otherwise specified. For those of ordinary skill in the art, the specific meanings of the above terms in the utility model may be understood according to specific situations.

In the utility model, unless otherwise specified and limited, a first feature is “above” or “below” a second feature may mean that the first feature and the second feature are in direct contact, or the first feature and the second feature are in indirect contact through an intermediary. Further, the first feature is “above” the second feature may be that the first feature is directly above or obliquely above the second feature, or it only means that a level of the first feature is higher than that of the second feature; and the first feature is “below” the second feature may be that the first feature is directly below or obliquely below the second feature, or it only means that the level of the first feature is lower than that of the second feature.

It should be noted that when an element is described as being “fixed to” or “arranged on” another element, it may be directly on another element or there may be an intermediate element. When an element is considered to be “connected” to another element, it may be directly connected to another element or there may be an intermediate element. The terms “vertical”, “horizontal”, “upper”, “lower”, “left”, “right” and similar expressions used herein are for the purpose of illustration only, and are not meant to be the only implementation way.

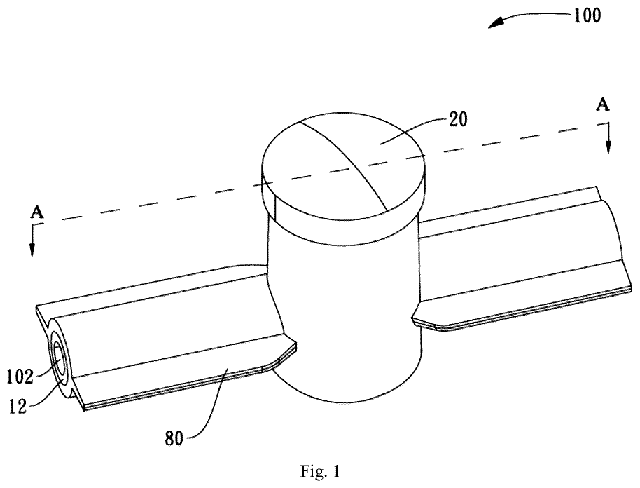

Referring to FIGS. 1-10, an inflatable bra according to an embodiment of the utility model comprises a novel valve 100. The novel valve 100 comprises a bracket 10, a sealing plug 20, a supporting block 30 and an air valve 40. One end of the bracket 10 is provided with an air inlet 101, and one side of the bracket 10 is provided with an air outlet 102 communicating with the air inlet 101. The sealing plug 20 is used for closing or opening the air inlet 101. The supporting block 30 is arranged at an end, near the air inlet 101, of the bracket 10, and the supporting block 30 is provided with a through hole 301. One end of the through hole 301 communicates with the air inlet 101, and the other end communicates with the air outlet 102. The air valve 40 is movably connected in the bracket 10, and the air valve 40 is used for closing or opening the through hole 301. The novel valve 100 is arranged at the end, near the air inlet 101, of the bracket 10 through the supporting block 30, and the air valve 40 opens or closes the through hole 301, thereby realizing inflation or deflation. The air inlet 101 can be sealed by the sealing plug 20, and the through hole 301 can be closed by the air valve 40, thus improving the air tightness.

### Embodiment I

As shown in FIGS. 1-3, in this embodiment, one end of the bracket 10 is provided with the air inlet 101, and one side of the bracket 10 is provided with the air outlets 102 communicating with the air inlet 101. Optionally, the bracket 10 comprises an air inlet pipe 11, air outlet pipes 12 and a bottom cover 13, with the air inlet 101 at one end of the air inlet pipe 11 and the air outlet 102 at one end of the air outlet pipe 12. The air outlet pipe 12 communicates with one side of the air inlet pipe 11, and the bottom cover 13 covers an end, away from the air inlet 101, of the air inlet pipe 11. Further, one end of the air outlet pipe 12 communicates with an object to be inflated, and there are two air outlet pipes 12, which both communicate with the air inlet pipe 11. In one embodiment, the air outlet pipe 12 is riveted to the air inlet pipe 11, and the bottom cover 13 is riveted to the air inlet pipe 11. The bracket 10 is made of metal. The object to be inflated is an airbag. In one embodiment, the sealing plug 20 is used for closing or opening the air inlet 101, and optionally, the sealing plug 20 is connected to the air inlet pipe 11 in a threaded mode, making it convenient for use.

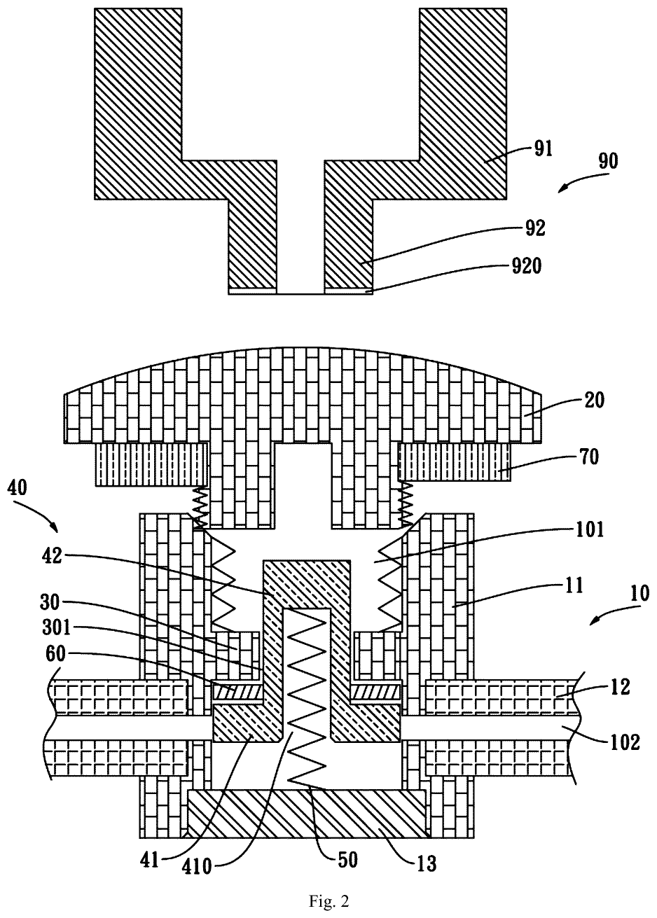

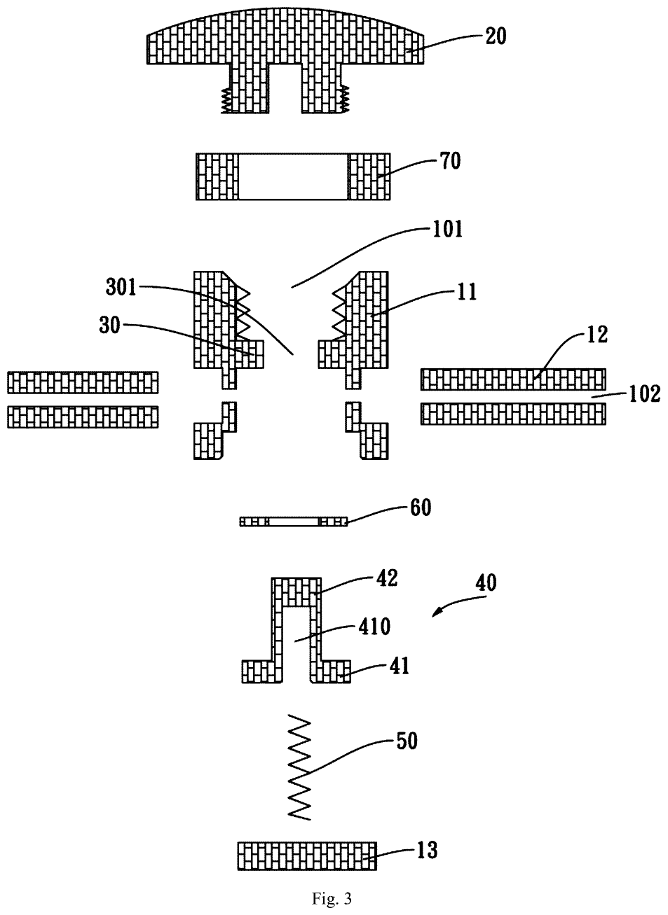

As shown in FIGS. 2 and 3, the supporting block 30 is arranged at the end, near the air inlet 101, of the bracket 10, the supporting block 30 is provided with the through hole 301, one end of the through hole 301 communicates with the air inlet 101, and the other end of the through hole 301 communicates with the air outlet 102. Optionally, the supporting block 30 is arranged inside the air inlet pipe 11.

Still referring to FIGS. 2 and 3, the air valve 40 is movably connected in the bracket 10, and the air valve 40 is used for closing or opening the through hole 301. The air valve 40 comprises a bottom plate 41 and a protrusion 42 connected to the bottom plate 41, the bottom plate 41 is used for being connected to one side of the supporting block 30, the protrusion 42 penetrates through the supporting block 30, and the through hole 301 is used for receiving the protrusion 42. Optionally, the bottom plate 41 is provided with a receiving cavity 410. Further, the bottom plate 41 is used for closing or opening the air outlet pipe 12. The diameter of the through hole 301 is larger than the width of the cross section of the protrusion 42, allowing the through hole 301 to communicate with the air outlet pipe 12.

In one embodiment, the novel valve 100 further comprises an elastic member 50, one end of the elastic member 50 abuts against a bottom of the bracket 10 and the other end abuts against the air valve 40. Optionally, one end of the elastic member 50 abuts against the bottom cover 13 and the other end abuts against the air valve 40. Further, one end of the elastic member 50 is located in the receiving cavity 410. In one embodiment, the elastic member 50 is a spring.

As shown in FIGS. 2 and 3, the novel valve 100 further comprises a jacket 60, the jacket 60 is sleeved on the protrusion 42, one side of the jacket 60 abuts against the bottom plate 41, and the other side is used for abutting against one side of the supporting block 30, thereby improving the air tightness. The novel valve 100 further comprises a sealing member 70, and the sealing member 70 is sleeved at one end of the sealing plug 20, and is used for sealing the air inlet pipe 11, so as to improve the air tightness. The novel valve 100 further comprises a housing 80, and the housing 80 covers the bracket 10. Optionally, the housing 80 is made of a plastic material.

As shown in FIG. 2, the novel valve 100 further comprises a valve sleeve 90, the valve sleeve 90 comprises a shell 91 and a conduit 92 communicating with the shell 91, and the shell 91 is used for abutting against one end of the bracket 10. An end, away from the shell 91, of the conduit 92 is used for abutting against the protrusion 42, and the end, away from the shell 91, of the conduit 92 is provided with an air slot 920. Optionally, the shell 91 abuts against the end, provided with the air inlet 101, of the air inlet pipe 11.

During inflation, the sealing plug 20 is opened, so that the sealing plug 20 is separated from the air inlet pipe 11; then, the sealing plug is inserted into the valve sleeve 90 to make the conduit 92 abut against the protrusion 42 until the shell 91 abuts against the air inlet pipe 11; at this point, the conduit 92 drives the air valve 40 to move towards the bottom cover 13 until the jacket 60 and the bottom plate 41 open the air outlet pipes 12 and the air outlet pipes 12 communicate with the through hole 301; then, air flow output by an air pump enters the air inlet pipe 11 through the conduit 92 and the air slot 920, then enters the air outlet pipes 12 through the through hole 301, and then flows into the object to be inflated. After inflation is completed, the valve sleeve 90 is pulled out; at this point, under the action of the elastic member 50, the air valve 40 moves away from the bottom cover 13 until the jacket 60 abuts against the supporting block 30, thus closing the through hole 301; at this point, the bottom plate 41 closes the air outlet pipes 12, and then the air inlet pipe 11 is closed by the sealing plug 20; and the air tightness is further improved under the action of the sealing member 70.

When deflation is required, the sealing plug 20 is opened and inserted into the valve sleeve 90, so that the conduit 92 abuts against the protrusion 42. As the conduit 92 presses down, the protrusion 42 moves towards the bottom cover 13, so that the jacket 60 and the bottom plate 41 open the air outlet pipes 12 and the air outlet pipes 12 communicate with the through hole 301 to realize deflation. According to the novel valve 100, the through hole 301 is sealed through the jacket 60, the bottom plate 41 seals the air outlet pipes 12, and the sealing member 70 seals the air inlet pipe 11, thus realizing triple sealing and achieving a good air leakage prevention effect.

### Embodiment II

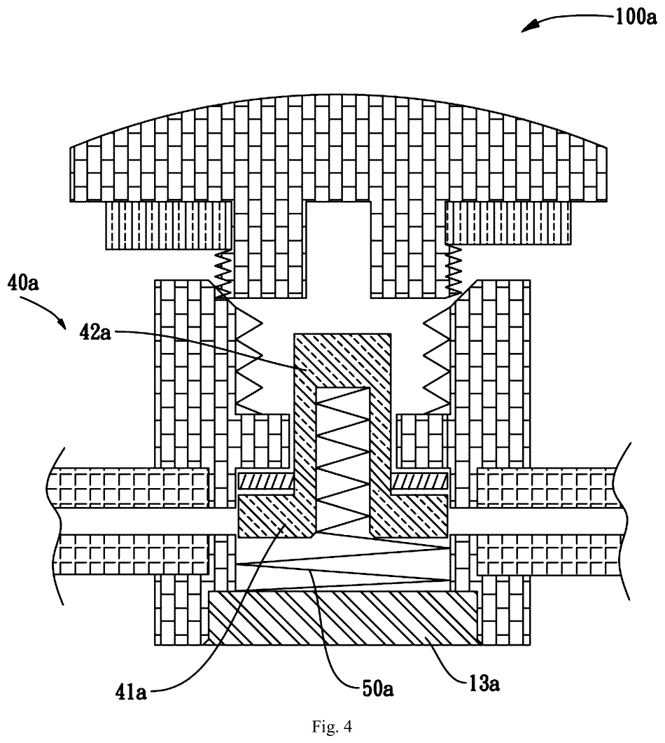

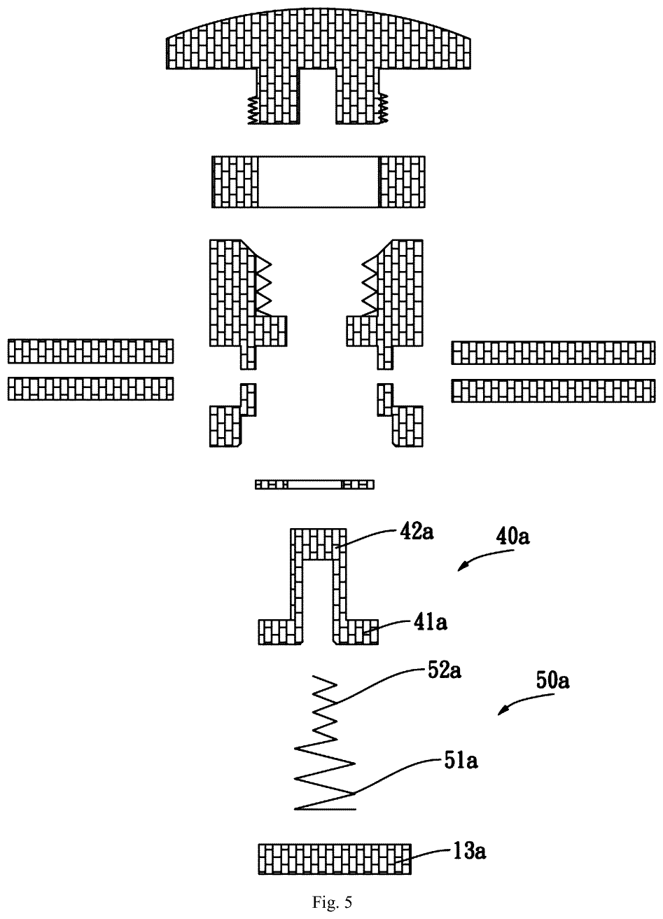

Please refer to FIGS. 4 and 5, which show a novel valve 100a in a second embodiment of this utility model. This embodiment is similar to the novel valve 100 in the first embodiment, except that an elastic member 50a of the novel valve 100a in this embodiment comprises a first elastic part 51a and a second elastic part 52a connected with the first elastic part 51a. An end, away from the second elastic part 52a, of the first elastic part 51a abuts against a bottom cover 13a, and the other end abuts against a bottom plate 41a. An end, away from the first elastic part 51a, of the second elastic part 52a is inserted into an air valve 40a. Optionally, the width of the cross section of the first elastic part 51a is greater than the width of the cross section of the second elastic part 52a.

### Embodiment III

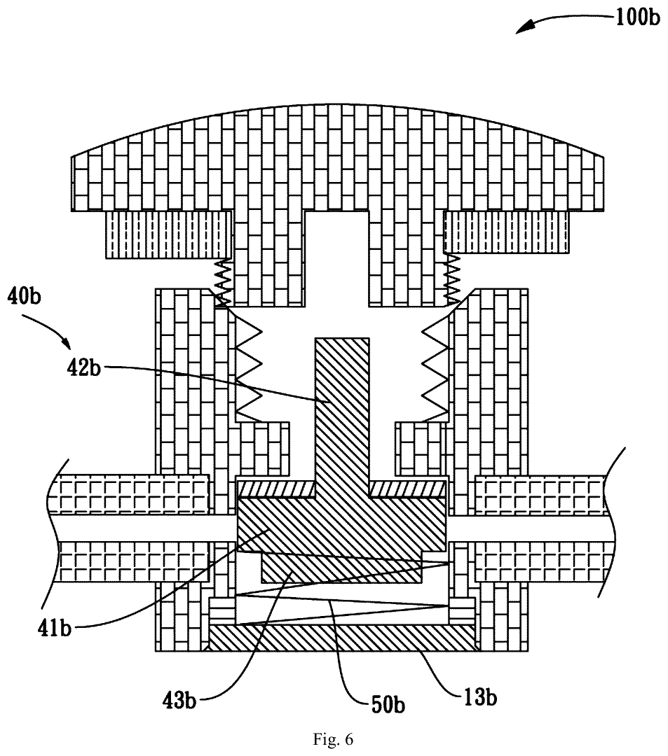

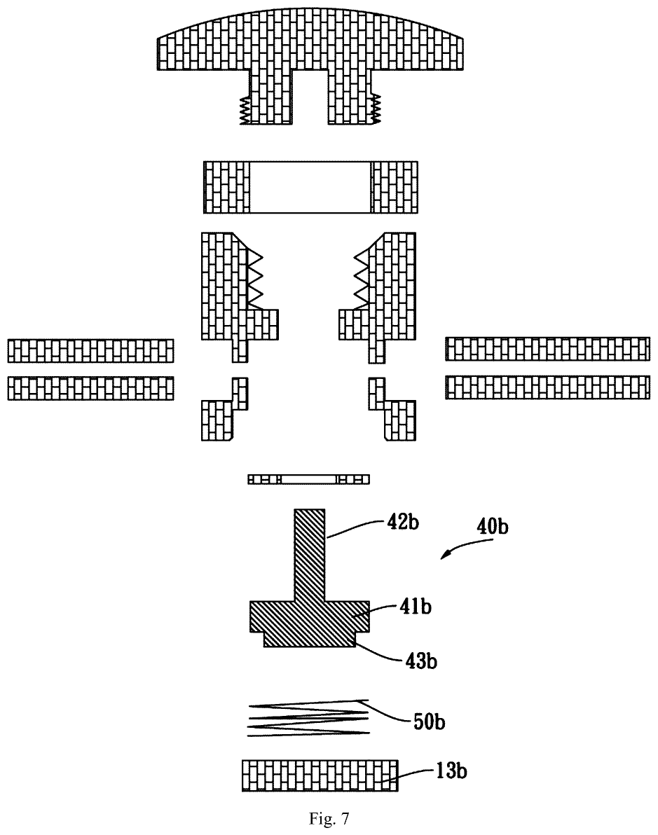

Please refer to FIGS. 6 and 7, which show a novel valve 100b in a third embodiment of this utility model. This embodiment is similar to the novel valve 100 of the first embodiment, except that an air valve 40b of the novel valve 100b of this embodiment comprises a bottom plate 41b, a protrusion 42b and a boss 43b, the protrusion 42b and the boss 43b are respectively connected to two sides of the bottom plate 41b, an elastic member 50b is sleeved on the protrusion 42b, one end of the elastic member 50b abuts against a bottom cover 13b, and the other end abuts against the bottom plate 41b.

### Embodiment IV

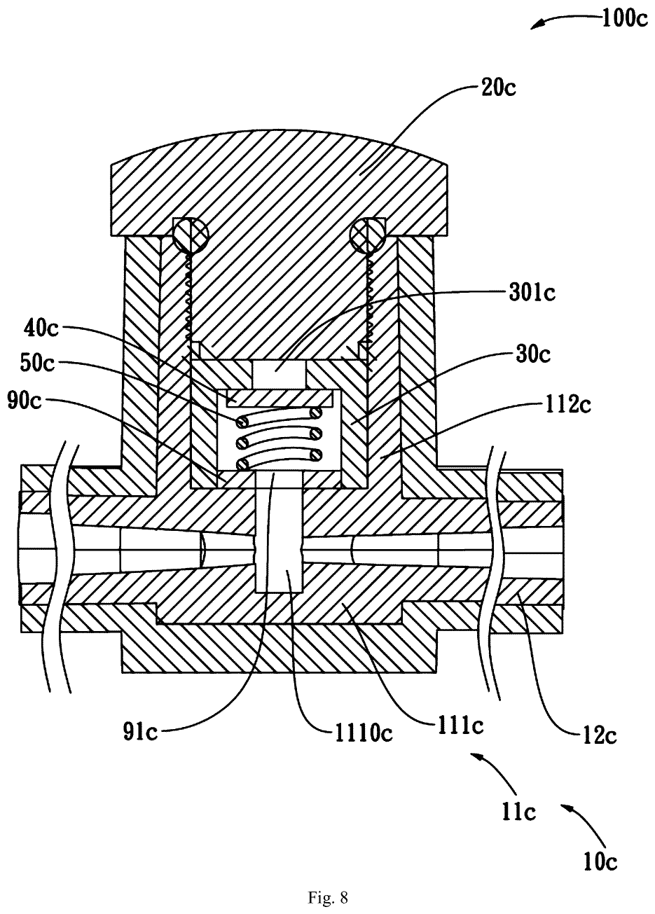

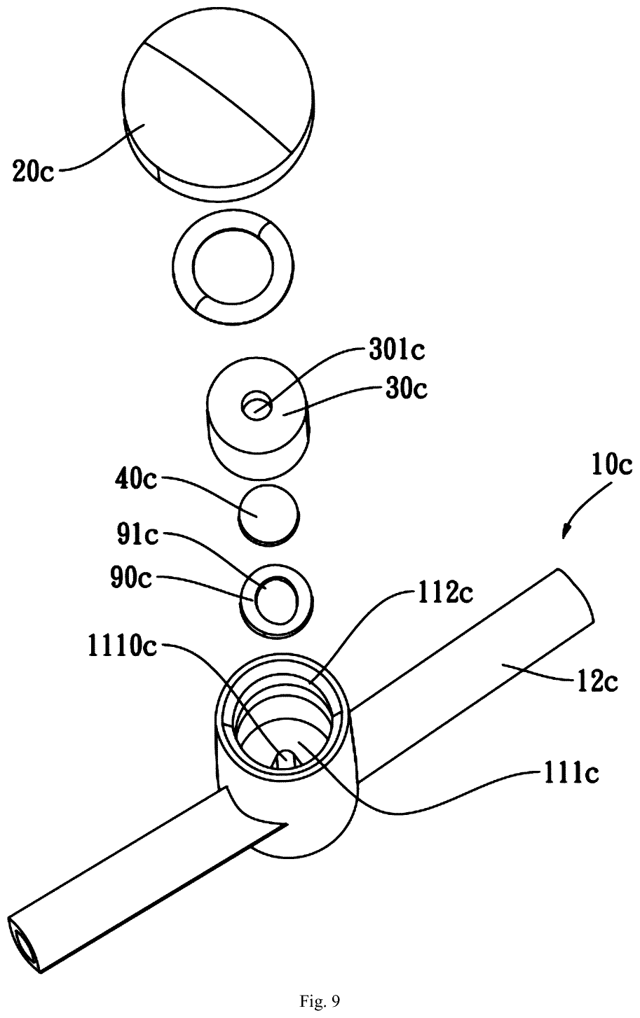

Please refer to FIGS. 8 and 9, which show a novel valve 100c in a fourth embodiment of this utility model. This embodiment is similar to the novel valve 100 in the first embodiment, except that an air inlet pipe 11c of the novel valve 100c in this embodiment comprises a base part 111c and a pipe part 112c connected with the base part 111c. Optionally, the base part 111c is provided with an air hole 1110c, one end of the air hole 1110c communicates with an air outlet pipe 12c, and the other end communicates with the pipe part 112c. Further, the air inlet pipe 11c and the air outlet pipe 12c are integrally formed. A supporting block 30c is hollow and cylindrical, one end of the supporting block 30c abuts against the base part 111c, and the supporting block 30c is located in the pipe part 112c. An air valve 40c is flat, and is movably connected in the supporting block 30c. The novel valve 100c further comprises a gasket 90c, and the gasket 90c is installed at an end, away from a through hole 301c, of the supporting block 30c. Optionally, the gasket 90c is provided with a via hole 91c, one end of the via hole 91c communicates with the through hole 301c, and the other end communicates with the air outlet pipe 12c. Further, the gasket 90c is installed on the base part 111c, and the air hole 1110c communicates with the via hole 91c. One end of an elastic member 50c abuts against the gasket 90c, and the other end abuts against the air valve 40c. The novel valve 100c of this embodiment does not comprise a jacket.

During inflation, a sealing plug 20c is opened; at this point, the elastic member 50c lifts the air valve 40c to make the air valve 40c abut against one end of the supporting block 30c; air flow output by an air pump compresses the elastic member 50c through the through hole 301c to keep the air valve 40c away from the through hole 301c, then flows into the air hole 1110c through the via hole 91c, and then flows into an object to be inflated through the air outlet pipe 12c. After the inflation is completed, the air pump is pulled out, and under the action of the elastic member 50c, the air valve 40c closes the through hole 301c to prevent the air in the object to be inflated from flowing out of the through hole 301c. Moreover, the air flow in the object to be inflated forces the air valve 40c to closely adhere to the supporting block 30c, and then the air inlet pipe 11c is closed by the sealing plug 20c.

### Embodiment V

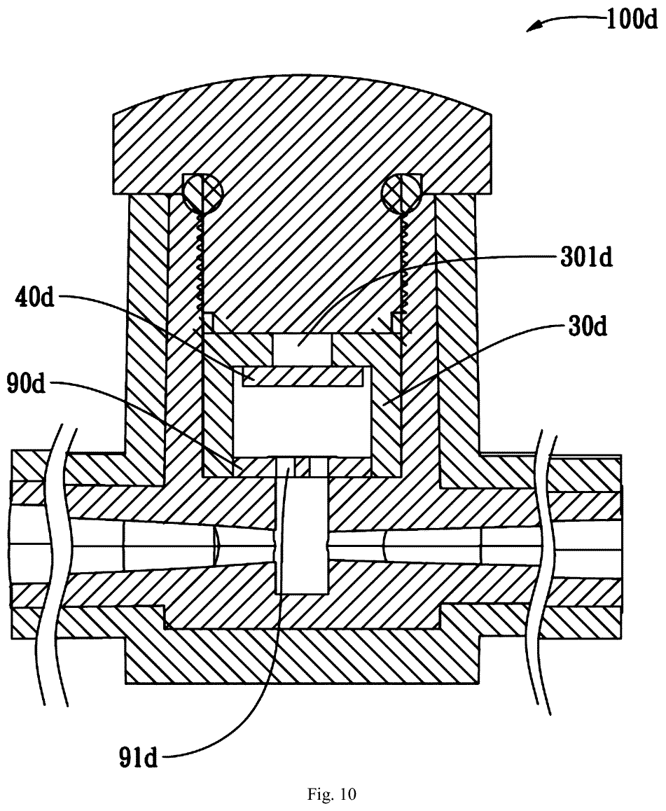

Please refer to FIG. 10, which shows a novel valve 100d in a fifth embodiment of this utility model. This embodiment is similar to the novel valve 100c in the fourth embodiment, except that the novel valve 100d in this embodiment does not comprise an elastic member, and a gasket 90d is used to support an air valve 40d which is movably connected in a supporting block 30d. The gasket 90d is provided with a plurality of via holes 91d which are arranged along the circumference of the gasket 90d. During inflation, the air valve 40d abuts against the gasket 90d, there is a gap between the air valve 40d and the via hole 91d for airflow, and a through hole 301d is in an open state. Air flow output by an air pump enters the supporting block 30d through the through hole 301d, and then enters an air hole through the via hole 91d. After the inflation is completed, the air pump is pulled out; and at this point, the air flow in an object to be inflated forces the air valve 40d to rise and close the through hole 301d to prevent the air in the object to be inflated from leaking out.

### Embodiment VI

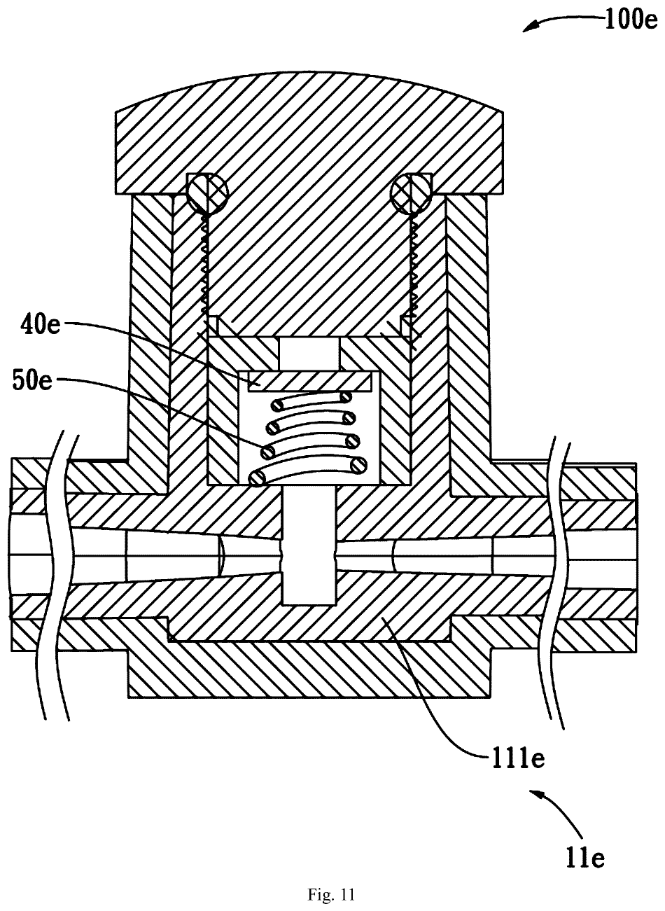

Please refer to FIG. 11, which shows a novel valve 100e in a sixth embodiment of the utility model. This embodiment is similar to the novel valve 100c in the fourth embodiment, except that an elastic member 50e of the novel valve 100e in this embodiment is in the shape of a truncated cone, one end of the elastic member 50e abuts against a base part 111e, and the other end abuts against an air valve 40e. The novel valve 100e in this embodiment does not comprise a gasket.

The novel valve 100 in this embodiment is arranged at the end, near the air inlet 101, of the bracket 10 through the supporting block 30, and the air valve 40 opens or closes the through hole 301, thereby realizing inflation or deflation. The air inlet 101 can be sealed by the sealing plug 20, and the through hole 301 can be closed by the air valve 40, thus improving the air tightness. The novel valve 100 is convenient to use and has a good air leakage prevention effect.

The technical features of the above embodiments can be combined freely. In order to make the description concise, all possible combinations of the technical features in the above embodiments are not described. However, as long as there is no contradiction in the combinations of these technical features, they should be considered as falling in the scope recorded in this specification.

The above embodiments only represent several implementation ways of the utility model, and their descriptions are specific and detailed, but they cannot be understood as limiting the scope of the patent of the utility model. It should be pointed out that, for those of ordinary skill in the art, without departing from the concept of the utility model, several modifications and improvements can be made, which belong to the protection scope of the utility model. Therefore, the scope of protection of the patent of the utility model shall be subject to the appended Claims.

What is claimed is:

1. A novel valve, comprising a bracket, a sealing plug, a supporting block and an air valve, wherein one end of the bracket is provided with an air inlet, and one side of the bracket is provided with an air outlet communicating with the air inlet; the sealing plug is used for closing or opening the air inlet, the supporting block is arranged at an end, near the air inlet, of the bracket, and the supporting block is provided with a through hole; one end of the through hole communicates with the air inlet, and the other end communicates with the air outlet; and the air valve is movably connected in the bracket, and the air valve is used for closing or opening the through hole.

2. The novel valve according to claim 1, wherein the bracket comprises an air inlet pipe, an air outlet pipe and a bottom cover, with the air inlet at one end of the air inlet pipe and the air outlet at one end of the air outlet pipe; and the air outlet pipe communicates with one side of the air inlet pipe, and the bottom cover covers an end, away from the air inlet, of the air inlet pipe.

3. The novel valve according to claim 2, further comprising a sealing member and a housing, wherein the sealing member is sleeved at one end of the sealing plug and used for sealing the air inlet pipe, and the housing covers the bracket.

4. The novel valve according to claim 2, further comprising an elastic member, wherein one end of the elastic member abuts against the bottom cover, and the other end abuts against the air valve.

5. The novel valve according to claim 4, further comprising a gasket, wherein the gasket is installed at an end, away from the through hole, of the supporting block, the gasket is provided with a via hole, one end of the via hole communicates with the through hole and the other end communicates with the air outlet pipe, and the gasket is used for supporting the air valve.

6. The novel valve according to claim 5, wherein one end of the elastic member abuts against the gasket, and the other end abuts against the air valve.

7. The novel valve according to claim 1, wherein the air valve comprises a bottom plate and a protrusion connected to the bottom plate, the bottom plate is used for being connected to one side of the supporting block, and the protrusion penetrates through the supporting block.

8. The novel valve according to claim 7, further comprising a jacket, wherein the jacket is sleeved on the protrusion, one side of the jacket abuts against the bottom plate, and the other side is used for abutting against one side of the supporting block.

9. The novel valve according to claim 7, further comprising a valve sleeve, wherein the valve sleeve comprises a shell and a conduit communicating with the shell, the shell is used for abutting against one end of the bracket, an end, away from the shell, of the conduit is used for abutting against the protrusion, and the end, away from the shell, of the conduit is provided with an air slot.

10. An inflatable bra, comprising the novel valve according to claim 1.
